(19) United States
(12) Patent Application Publication
(10) Pub. No.: US 2024/0213540 A1
(43) Pub. Date: Jun. 27, 2024

(54) LITHIUM-METAL RECHARGEABLE ELECTROCHEMICAL CELLS WITH LIQUID ELECTROLYTES AND SINGLE-CRYSTAL NICKEL-MANGANESE-COBALT

(71) Applicant: Cuberg, Inc., San Leandro, CA (US)

(72) Inventors: Michael McEldrew, San Leandro, CA (US); Lauren Nicole Burke, Oakland, CA (US); Thomas Patrick Whitehill-Nigl, El Cerrito, CA (US); Vicky Thi Huynh, Elk Grove, CA (US); Aaron R. Garg, San Francisco, CA (US); Sanjay Nanda, San Francisco, CA (US); Richard Wang, Danville, CA (US)

(73) Assignee: Cuberg, Inc., San Leandro, CA (US)

(21) Appl. No.: 18/394,380

(22) Filed: Dec. 22, 2023

Related U.S. Application Data
(60) Provisional application No. 63/476,681, filed on Dec. 22, 2022.

(51) Int. Cl. H01M 10/0568; H01M 4/02; H01M 4/38; H01M 4/505; H01M 4/525; H01M 10/0569

(52) U.S. Cl. CPC H01M 10/0568; H01M 4/382; H01M 4/505; H01M 4/525; H01M 10/0569; H01M 2004/021; H01M 2004/027; H01M 2004/028; H01M 2300/0034

(57) ABSTRACT

Described herein are lithium-metal rechargeable electrochemical cells comprising positive single-crystal nickel-manganese-cobalt (NMC)-containing structures and liquid electrolytes comprising one or more imide-containing salts, such as bis(trifluoromethanesulfonyl)imide (TFSI−)-containing salts, bis(fluorosulfonyl)imide (FSI⁻)-containing salts, and bis(pentafluoroethanesulfonyl)imide (BETI⁻)-containing salts. These salts can also include various cations, such as lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺). For example, imide-containing salts can act as a source of lithium ions in lithium-metal salts. In some examples, the liquid electrolyte further comprises one or more of 1,2-dimethoxyethane (DME), 2,2,2-Trifluoroethyl Ether (TFEE), 1,1,2,2-Tetrafluoroethyl 2,2,3,3-tetrafluoropropyl ether (TFPE), one or more phosphites, and one or more phosphates. In some examples, the liquid electrolyte has a lithium-ion activity of at least 370 mV or even at least about 390 mV (vs. 1M LiFSI in DME at 25° C.). Furthermore, the single-crystal NMC-containing structures can have a nickel concentration of at least 70% atomic.

### CROSS-REFERENCE TO RELATED APPLICATIONS

This application claims the benefit under 35 U.S.C. § 119(e) of U.S. Provisional Patent Application 63/475,681, filed on 2022 Dec. 22, which is incorporated herein by reference in its entirety for all purposes.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries resulted in many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite. However, Li-metal cells or, more generally, Li-metal batteries are currently not widely adopted at the scale of Li-ion batteries for various reasons. For example, repeated plating and stripping of lithium metal can form a porous lithium structure, which negatively impacts the further performance and cycle life of Li-metal cells. The plating characteristics of lithium metal depend in large part on the electrolyte composition. Furthermore, the composition and morphology of positive active materials play an important role in selecting electrolyte formulations.

What is needed are new electrolyte formulations and lithium-metal rechargeable electrochemical cells fabricated with these electrolytes that have improved performance.

### SUMMARY

Described herein are lithium-metal rechargeable electrochemical cells comprising positive single-crystal nickel-manganese-cobalt (NMC)-containing structures and liquid electrolytes comprising one or more imide-containing salts, such as bis(trifluoromethanesulfonyl)imide (TFSI−)-containing salts, bis(fluorosulfonyl)imide (FSI⁻)-containing salts, and bis(pentafluoroethanesulfonyl)imide (BETI⁻)-containing salts. These salts can also include various cations, such as lithium (Li⁺), potassium (K⁺), sodium (Na⁺), cesium (Cs⁺), n-propyl-n-methylpyrrolidinium (Pyr13+), n-octyl-n-methylpyrrolidinium (Pyr18+), and 1-methyl-1-pentylpyrrolidinium (Pyr15⁺). For example, imide-containing salts can act as a source of lithium ions in lithium-metal salts. In some examples, the liquid electrolyte further comprises one or more of 1,2-dimethoxyethane (DME), 2,2,2-Trifluoroethyl Ether (TFEE), 1,1,2,2-Tetrafluoroethyl 2,2,3,3-tetrafluoropropyl ether (TFPE), one or more phosphites, and one or more phosphates. In some examples, the liquid electrolyte has a lithium-ion activity of at least 370 mV or even at least about 390 mV (vs. 1M LiFSI in DME at 25° C.). Furthermore, the single-crystal NMC-containing structures can have a nickel concentration of at least 70% atomic.

Clause 1. A lithium-metal rechargeable electrochemical cell comprising: a lithium-metal negative electrode; a positive electrode comprising a single-crystal nickel-manganese-cobalt (NMC)-containing structures; and a liquid electrolyte providing an ionic conductivity between the lithium-metal negative electrode and the positive electrode and comprising one or more imide-containing salt selected from the group consisting of a bis(trifluoromethanesulfonyl)imide (TFSI−)-containing salt, a bis(fluorosulfonyl)imide (FSI⁻)-containing salt, and a bis(pentafluoroethanesulfonyl)imide (BETI⁻)-containing salt.

Clause 2. The lithium-metal rechargeable electrochemical cell of clause 1, wherein the one or more imide-containing salts comprise cations selected from the group consisting of lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺).

Clause 3. The lithium-metal rechargeable electrochemical cell of clause 1, wherein the one or more imide-containing salts comprise n-propyl-n-methylpyrrolidinium (Pyr13).

Clause 4. The lithium-metal rechargeable electrochemical cell of clause 1, wherein the one or more imide-containing salts comprises n-propyl-n-methylpyrrolidinium bis(fluorosulfonyl)imide (Pyr13-FSI).

Clause 5. The lithium-metal rechargeable electrochemical cell of clause 4, wherein the n-propyl-n-methylpyrrolidinium bis(fluorosulfonyl)imide (Pyr13-FSI) has a concentration of at least 10% by weight in the liquid electrolyte.

Clause 6. The lithium-metal rechargeable electrochemical cell of clause 5, wherein the imide-containing salt further comprises n-propyl-n-methylpyrrolidinium bis(trifluoromethanesulfonyl)imide (Pyr13-TFSI).

Clause 7. The lithium-metal rechargeable electrochemical cell of clause 6, wherein the n-propyl-n-methylpyrrolidinium bis(fluorosulfonyl)imide (Pyr13-FSI) has a higher concentration than the n-propyl-n-methylpyrrolidinium bis(trifluoromethanesulfonyl)imide (Pyr13-TFSI).

Clause 8. The lithium-metal rechargeable electrochemical cell of clause 4, wherein the propyl-n-methylpyrrolidinium bis(trifluoromethanesulfonyl)imide (Pyr13-TFSI) has a concentration of at least 5% by weight in the liquid electrolyte.

Clause 9. The lithium-metal rechargeable electrochemical cell of clause 1, wherein the one or more imide-containing salts have a total concentration of between 10% by weight and 60% by weight.

Clause 10. The lithium-metal rechargeable electrochemical cell of clause 1, wherein the one or more imide-containing salts consist of a single imide-containing salt having a concentration of less than 20% by weight.

Clause 11. The lithium-metal rechargeable electrochemical cell of clause 1, wherein the one or more imide-containing salts are oxidatively stable at voltages of at least about 4.2V.

Clause 12. The lithium-metal rechargeable electrochemical cell of clause 1, wherein the one or more imide-containing salts comprise lithium cations.

Clause 13. The lithium-metal rechargeable electrochemical cell of clause 1, wherein the one or more imide-containing salts comprise lithium bis(fluorosulfonyl)imide (LiFSI).

Clause 14. The lithium-metal rechargeable electrochemical cell of clause 13, wherein: the one or more imide-containing salts further lithium bis(trifluoromethanesulfonyl)imide (LiTFSI), and the lithium bis(trifluoromethanesulfonyl)imide (LiTFSI) has a lower concentration than lithium bis(fluorosulfonyl)imide (LiFSI) in the liquid electrolyte.

Clause 15. The lithium-metal rechargeable electrochemical cell of clause 13, wherein lithium bis(trifluoromethanesulfonyl)imide (LiTFSI) has a concentration of less than 5% by weight in the liquid electrolyte.

Clause 16. The lithium-metal rechargeable electrochemical cell of clause 1, wherein the liquid electrolyte has a lithium-ion activity of at least 370 mV vs. 1M LiFSI in DME at 25° C.

Clause 17. The lithium-metal rechargeable electrochemical cell of clause 1, wherein the liquid electrolyte has a lithium-ion activity of at least 390 mV vs. 1M LiFSI in DME at 25° C.

Clause 18. The lithium-metal rechargeable electrochemical cell of clause 1, wherein nickel has a concentration of at least 70% atomic in the single-crystal NMC-containing structures.

Clause 19. The lithium-metal rechargeable electrochemical cell of clause 1, wherein nickel has a concentration of at least 80% atomic in the single-crystal NMC-containing structures.

Clause 20. The lithium-metal rechargeable electrochemical cell of clause 1, wherein the single-crystal NMC-containing structures have an average particle size of less than 8 micrometers.

Clause 21. The lithium-metal rechargeable electrochemical cell of clause 1, wherein the liquid electrolyte further comprises one or more solvents selected from the group consisting of 2,2,2-Trifluoroethyl Ether (TFEE) and 1,1,2,2-Tetrafluoroethyl 2,2,3,3-tetrafluoropropyl ether (TFPE).

Clause 22. The lithium-metal rechargeable electrochemical cell of clause 21, wherein the one or more solvents comprise both 2,2,2-Trifluoroethyl Ether (TFEE) and 1,1,2,2-Tetrafluoroethyl 2,2,3,3-tetrafluoropropyl ether (TFPE).

### BRIEF DESCRIPTION OF THE DRAWINGS

FIG. 1A is a block diagram illustrating various components of a lithium-metal rechargeable electrochemical cell, in accordance with some examples.

FIG. 1B is a block diagram illustrating various components of an electrolyte of the lithium-metal rechargeable electrochemical cell, in accordance with some examples.

FIG. 2A are capacity retention plots corresponding to two lithium-metal rechargeable electrochemical cells, both fabricated with single-crystal NMC-containing structures with one using a reference electrolyte without any TFSI-containing salts and the other one using a test electrolyte comprising LiTFSI.

FIG. 2B are capacity retention plots corresponding to two lithium-metal rechargeable electrochemical cells, both fabricated with polycrystalline NMC-containing structures with one using a reference electrolyte without any TFSI-containing salts and the other one using a test electrolyte comprising LiTFSI.

FIG. 3A are capacity retention plots corresponding to two lithium-metal rechargeable electrochemical cells, both fabricated with single-crystal NMC-containing structures (with 83% atomic represented by nickel) with one using a reference electrolyte without any TFSI-containing salts and the other one using a test electrolyte comprising LiTFSI.

FIG. 3B are capacity retention plots corresponding to two lithium-metal rechargeable electrochemical cells, both fabricated with single-crystal NMC-containing structures (with 88% atomic represented by nickel) with one using a reference electrolyte without any TFSI-containing salts and the other one using a test electrolyte comprising LiTFSI.

FIGS. 3C-3E are capacity retention plots comprising single-crystal NMC-containing structures to polycrystalline NMC-containing structures across different electrolyte formulations.

FIG. 3F illustrates two oxidative stability curves demonstrating electrolyte oxidative stability with single-crystal NMC-containing structures.

FIG. 3G is a plot of Columbic efficiency over a number of cycles (1C-1D) for two lithium-metal cells fabricated with different electrolytes.

FIG. 3H is a plot showing the oxidative leakage current for two lithium-metal cells fabricated with different electrolytes.

FIG. 3I is a plot showing a model prediction for different electrolyte formulations.

FIG. 4 is a process flowchart corresponding to a method of fabricating a lithium-metal rechargeable electrochemical cell, in accordance with some examples.

FIG. 5 is a block diagram of an electric vehicle using lithium-metal rechargeable electrochemical cells, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### INTRODUCTION

Nickel-manganese-cobalt (NMC)-containing active materials, which are often referred to as NMC materials or simply NMC and which can be represented as LiNi_{1-x-y} MnₓCo_{y}O₂, are becoming popular positive active material alternatives to more conventional lithium cobalt oxide (LiCoO₂) in lithium-ion cells and lithium-metal cells. Specifically, NMC materials tend to be less expensive and have a high energy density in addition to providing a longer lifecycle in comparison to lithium cobalt oxide. The substitution of cobalt with nickel and manganese also mitigates various supply chain concerns. For example, Ni-rich NMC materials have demonstrated greater discharge capacities (exceeding 200 mAh g-1), which are particularly useful for electric vehicle applications such as electrical aerial vehicles. For purposes of this disclosure, Ni-rich NMC materials are defined as NMC-containing active materials in which the nickel content is at least 80% atomic.

However, NMC materials and, more specifically, Ni-rich NMC materials (e.g., nickel has a concentration of at least 70% atomic or even at least 80% atomic) present some challenges when used in lithium-ion cells and lithium-metal cells. For example, most NMC materials are polycrystalline materials in the form of secondary particles. When used in positive electrodes, these secondary particles can undergo structural deformations at higher states of charge/higher voltages (e.g., above 4.1V). These structural deformations are caused by the repeated volume expansion and contraction of the primary NMC particles, which form larger secondary particles. These deformations can lead to the intergranular cracking of the secondary particles (i.e., cracks forming between primary NMC particles) and to the overall degradation of the NMC layered structure. As these secondary particles deteriorate, additional surfaces become exposed to the electrolyte and cause the formation of additional resistive layers, which are sometimes referred to as cathode electrolyte interphase (CEI) layers. It should be noted that for purposes of this disclosure, a positive electrode can be referred to as a cathode, regardless of the charging or discharging state of the cell. Similarly, a negative electrode can be referred to as an anode, regardless of the charging or discharging state of the cell. In other words, “cathode” and “anode” are simply used to differentiate two electrodes regardless of the direction of the applied current.

Returning to CEI layers, these layers continue to form on the surface of the newly exposed primary particles when the secondary particles of polycrystalline NMC materials undergo cracking. These additional CEI layers can reduce the cell capacity and increase cell impeadance, which is evident by the capacity fade. However, polycrystalline NMC materials are currently more common than other types of NMC materials because of their costs and simple fabrication. For example, extreme processing conditions are needed for the synthesis of smaller particles with a narrow size distribution while preventing the agglomeration of these small primary structures into secondary structures. Such processes can include molten-salt synthesis, high-temperature annealing, and high-energy ball milling, all of which require either high temperatures or equipment that is expensive and/or difficult to scale. It should be noted that polycrystalline NMC materials can exist as unimodal polycrystalline structures and bimodal polycrystalline structures, both of which are different from single-crystal NMC structures.

It has been found that the capacity retention of NMC materials or, more specifically, Ni-rich NMC materials can be improved by using single-crystal NMC particles rather than polycrystalline particles in lithium-metal cells and, in some examples, in lithium-ion cells. The primary difference between single-crystal NMC-containing structures and polycrystalline structures is that single-crystal NMC-containing structures have ordered structures and symmetry (i.e., layered structure), while the long-range order in polycrystalline structures has been disrupted by aggregating the different orders of individual crystalline structures and random agglomeration of these individual structures. Furthermore, single-crystal NMC-containing structures have stronger internal bonds than the bonds within polycrystalline structures (e.g., the bonds between individual particles within each polycrystalline structure). Finally, single-crystal NMC-containing structures can be smaller than polycrystalline structures. For example, single-crystal NMC-containing structures may have an average particle size of less than 8 micrometers, less than 6 micrometers, or even less than 4 micrometers. For comparison, a typical average particle size for polycrystalline NMC-containing structures is at least 10 micrometers (due to the agglomeration of multiple primary structures). As noted above, the smaller particle sizes correspond to larger surface areas and, as a result, to higher charge-discharge rates. It should be noted that while some primary particle-to-primary particle direct adhesion is possible in single-crystal electrode formulations, this type of adhesion is minimal (e.g., less than 10% of the overall particles). On the contrary, most primary particles in polycrystalline electrode formulations are bonded to each other.

Because the bonds within the primary particles are stronger than between primary particles (in polycrystalline materials), single-crystal NMC particles inherently do not display intergranular cracking in a way that polycrystalline NMC particles do. Furthermore, single-crystal NMC particles tend to have higher specific capacities due to the greater surface-area-to-volume ratio of the individual particles vs. secondary-particle agglomerates of polycrystalline NMC materials. However, the increased surface area exposed to the electrolyte also provides more surface for the CEI layer formation. These CEI layers can be resistive and increase the overall cell impedance. Furthermore, if the CEI layer formation reaches a critical point (i.e., increase the cell resistance above a set threshold), further cycling (to higher voltages) accelerates the CEI layer formation leading to accelerated capacity loss. Specifically, the electrolyte stability tends to be highly sensitive to a voltage at the positive electrode surface. Increasing this voltage stimulates electrolyte decomposition and further CEI layer formation.

It should be noted that various additional factors can contribute to capacity loss, such as electrolyte depletion and electronic disconnection of positive active materials. Furthermore, it should be noted that capacity loss can have a non-linear behavior, which can be characterized by “rollover”. For purposes of this disclosure, rollover is defined as a point at which a derivative of the capacity retention plot drops below −1. In other words, at the rollover point, the asymptote angle with the cycle axis is 45°. The rollover point can correspond to the cell resistance reaching a set threshold discussed above.

This “rollover” phenomenon is predominant in cells using single-crystal NMC particles or, more specifically, single-crystal nickel-rich NMC particles due to various factors, such as low SoC resistance growth, which can be caused by electrolyte depletion. Specifically, single-crystal nickel-rich NMC particles have larger exposed surface areas (due to the smaller particle sizes) and, as a result, more of the interphase layer is formed (for a given weight of the positive active material). This interphase layer formation consumes various electrolyte components. It should also be mentioned that the “rollover” phenomenon is observed in both lithium-ion cells and lithium-metal cells. However, the underlying reason for the “rollover” phenomenon in lithium-metal cells is different from that in lithium-ion cells.

Specifically, lithium-metal cells are different from lithium-ion cells in the way lithium is deposited and stored on the negative electrode. In lithium-ion cells, lithium is intercalated or alloyed into negative electrode active materials, such as graphite or silicon. In lithium-metal cells, lithium metal is plated on the surface of the current collector as a free-standing metal layer. Over many cycles, the repeated plating and stripping of lithium metal can build up porous lithium metal structures on the negative electrode. These porous structures can have a significantly higher surface area in comparison to a starting lithium structure, such as lithium foil. The electrolyte is forced into these pores, resulting in electrolyte consumption and solid electrolyte interphase (SEI) layer formation. Like CEI layers described above, the SEI formation causes electrolyte depletion and increases the cell impedance (also adding to a larger overpotential described above and limiting the capacity available upon the discharge). As such, uniform lithium plating on the current collector can help to mitigate this failure mode.

It has been found that specific combinations of single-crystal NMC-containing structures and liquid electrolytes comprising one or more imide-containing salts can significantly improve the performance of lithium-metal rechargeable electrochemical cells addressing various failure modes described above. For example, single-crystal NMC particles are less prone to cracking than polycrystalline NMC particles thereby preserving their interparticle contacts. Single-crystal NMC particles, which are primary particles and are not agglomerated into secondary particles, have minimal/no strain on the lattice structure of the particles, thereby reducing any particle cracking almost entirely. Ultimately, in polycrystalline electrode formulations the degradation of the cathode active material is driven by interparticle cracking and secondary particle pulverization. This type of degradation can be largely unavoidable due to the necessary expansion and contraction of secondary particles during the charge and discharge cycles. On the other hand, single-crystal electrode formulations are thought to degrade via surface-driven reactions that form & degrade the CEI & electrolyte, respectively. This degradation mechanism implies that the degradation of the cathode active material can be driven by or mitigated by the appropriate electrolyte formulation.

Imide-containing salts (e.g., FSI-containing salts, TFSI-containing salts, and BETI-containing salts) decompose at the surface of positive active-material (cathode) particles at high voltages, leading to organic byproducts depositing on the surface and forming a protective cathode-electrolyte interphase (CEI) layer. As the battery cell is cycled, polycrystalline-NMC structures have a greater increase in surface area compared to single-crystal NMC structures, due to the cracking of the secondary agglomerated particles exposing additional surface area. This additional surface area is exposed to the electrolyte, resulting in additional surface layers being formed and composed of electrolyte byproducts. This phenomenon causes the increase in impedance of the positive electrode and leads to faster capacity decay (in comparison to single-crystal particles.)

Furthermore, NMC materials tend to experience most of their degradation at higher voltages (e.g., 4.2V and greater) due to unfavorable phase transitions experienced during charging delithiation. Specifically, NMC materials experience 4 crystalline phases, H1 (hexagonal), M (monoclinic), H2 (hexagonal), and H3 (hexagonal). The H3 phase is associated with high voltage degradation, and it occurs at 4.2V and higher. During this phase, Ni⁴⁺ evolves and reacts with the electrolyte, contributing to the positive electrode interface and rock salt formation. However, voltages of 4.2V and higher are needed to achieve competitive energy density, which presents additional challenges to the electrolyte formulations. It has been found that the addition of imide-containing salts (e.g., FSI-containing salts, TFSI-containing salts, and BETI-containing salts) helps with addressing this high-voltage decomposition issue.

Without being restricted to any theory, it is believed that imide-containing salts improve both lithium plating quality and high voltage stability in lithium-metal cells fabricated with single-crystal NMC-containing structures. For example, it is believed that imide-containing electrolytes have improved oxidative stability resulting in a delay in impedance growth. Furthermore, combining single-crystal NMC-containing structures with electrolytes comprising imide-containing salts helps to strain this oxidative stability further. For example, imide-containing salts can impact the solvation shell such that solvents with lower oxidative stability can become a part of this solvation shell.

These properties of imide-containing salts help to delay the impedance growth and positive active material loss, respectively.

### Examples of Lithium-Metal Rechargeable Electrochemical Cells

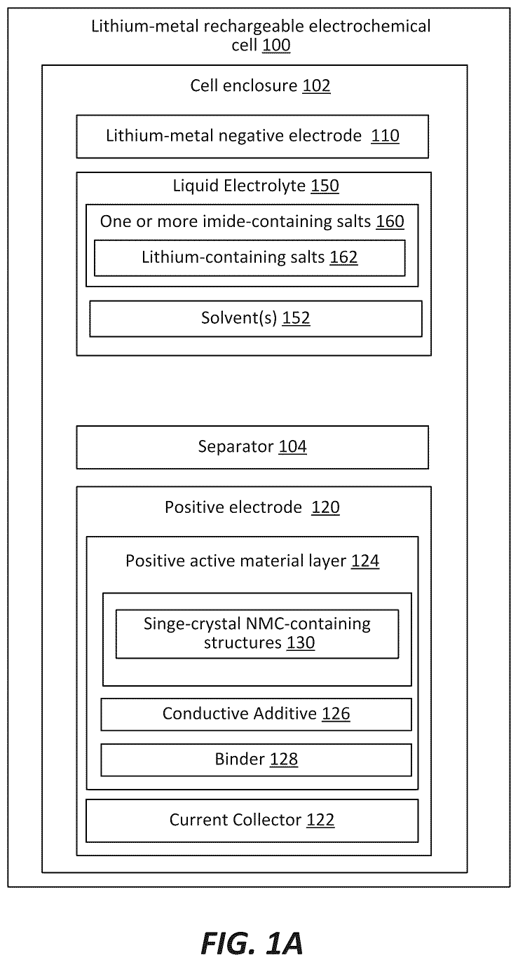

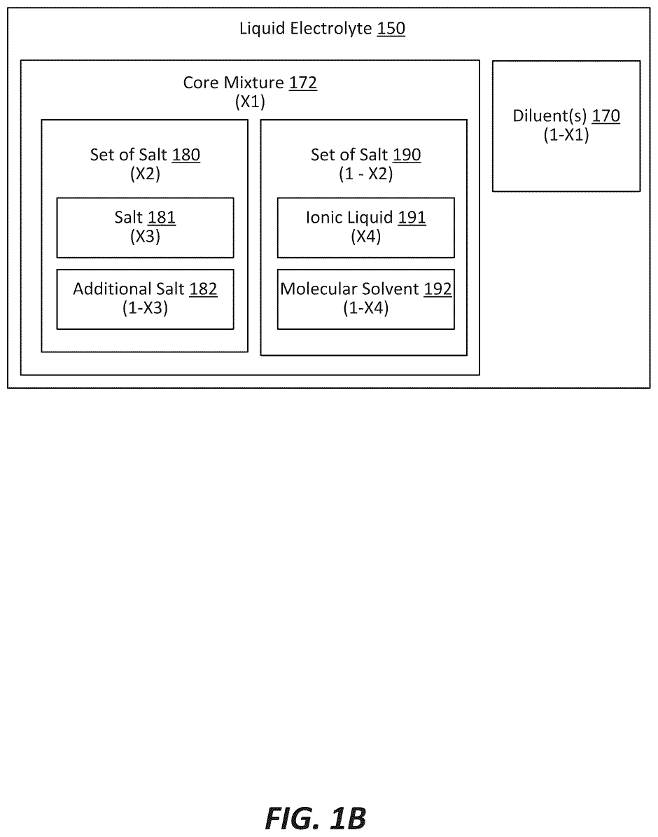

FIG. 1A is a block diagram illustrating various components of lithium-metal rechargeable electrochemical cell 100, in accordance with some examples. Lithium-metal rechargeable electrochemical cell 100 comprises lithium-metal negative electrode 110, positive electrode 120 comprising single-crystal NMC-containing structures 130, and liquid electrolyte 150 providing the ionic conductivity between lithium-metal negative electrode 110 and positive electrode 120. Lithium-metal rechargeable electrochemical cell 100 can also include other components, such as separator 104 and enclosure 102. Each of these components will now be described in more detail.

Lithium-metal negative electrode 110 comprises a lithium-metal layer, as a standalone structure or a supported using another non-lithium layer (e.g., another metal layer, a polymer layer, and the like). Some examples of non-lithium layers include, but are not limited to, copper, nickel, stainless steel, a metalized polymer substrate (e.g., metalized with copper), and a carbon-coated metal substrate. When these non-lithium layers are electronically conductive, these layers may be referred to as current collectors (used to transfer the current caused by lithium plating/stripping to cell terminals). The purpose of using a negative electrode with a lithium-metal layer deposited on a current collector (in lithium-metal electrochemical cells) is to reduce the size of the negative electrode (e.g., in comparison to lithium-ion cells). For example, the thickness of the lithium-metal layer can be less than 20 micrometers. Furthermore, the addition of a current collector also helps to keep the thickness of the lithium-metal layer small. For example, thicknesses of less than 20 micrometers are difficult to achieve/handle with freestanding lithium foil. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from a safety perspective as less lithium ejecta (e.g., molten lithium ejecta) needs to be contained when the cell goes into a thermal runaway. Alternatively, lithium-metal negative electrode 110 is formed entirely from a lithium-metal layer, which is sufficiently thick. In this example, a portion of this layer can be used as a current collector, while another portion is used as a source of lithium ions during the cell discharge.

Separator 104 provides physical and electronic isolation between lithium-metal negative electrode 110 and positive electrode 120. Additionally, separator 104 functions as an ionically conductive membrane that conveys lithium ions (in liquid electrolyte 150) between lithium-metal negative electrode 110 and positive electrode 120. Separator 104 can be a thin layer (e.g., 1-50 microns thick) with a porosity of 20-80% or, more specifically, 50-70%. Separator 104 may be composed of carbon-based polymer chains with or without inorganic compounds (e.g., aluminum oxide, titanium oxide) for reinforcement. Overall, separator 104 can be formed from one or more polyolefins (e.g., polyethylene, polypropylene) and/or non-polyolefin materials (e.g., cellulose, polyimide, polyethylene terephthalate (PET), and glass). In some variations, separator 104 may include a coating of or be layered with other material, e.g., ceramics, surfactant, and/or polymer with or without inorganic fillers.

Lithium-metal negative electrode 110, positive electrode 120, separator 104, and liquid electrolyte 150 can be referred to as internal components of lithium-metal rechargeable electrochemical cell 100. These internal components are sensitive to moisture and other ambient conditions and are insulated from the environment by cell enclosure 102. In some examples, cell enclosure 102 is formed from aluminum (e.g., for cylindrical or prismatic cells), a pouch laminate, and an aluminum-coated polymer (e.g., polyamide, polyester, polyurethane, and polypropylene).

Positive electrode 120 can comprise current collector 122 with one or multiple positive active material layers 124 adhered to and supported by current collector 122 (e.g., an aluminum foil). Each positive active material layer 124 comprises single-crystal NMC-containing structures 130 and, in some examples, other components, such as conductive additives 126 (e.g., carbon black/paracrystalline carbon, carbon nanotubes) and binder 128 (e.g., polyvinylidene fluoride (PVDF), styrene-butadiene rubber (SBR), and carboxyl methyl cellulose (CMC)). For purposes of this disclosure, “single-crystal NMC-containing structures” are defined as individual structures that are not directly agglomerated with each other such that each single-crystal structure is formed by an individual grain of layered metal oxides e.g., nickel oxide, manganese oxide, and cobalt oxide. Single-crystal NMC-containing structures 130 should be distinguished from polycrystalline structures, which are more common for NMC-containing materials, and which are defined as agglomerates of multiple different crystalline structures as described above.

In some examples, nickel has a concentration of at least 70% atomic in single-crystal NMC-containing structures 130 or even at least 80% atomic and even at least 85% atomic. The higher nickel concentration corresponds to a higher lithium storage capacity.

As noted above, liquid electrolyte 150 comprises one or more Imide-containing salts 160. For example, imide-containing salt 160 has a concentration of between 3% by weight and 30% by weight or, more specifically, between 5% by weight and 25% by weight or, even 10% by weight and 20% by weight. In the same or other examples, imide-containing salt 160 is oxidatively stable at voltages of at least about 4.2V or, more specifically, at least about 4.3V or even at least about 4.4V. For purposes of this disclosure, the term “oxidatively stable” means that subjecting the electrolyte (in an electrochemical cell) to a selected potential (i.e., voltage), the cell has a measured current density of <1 pA/cm² at steady-state. For practical purposes, steady-state can be approximated by times >24 hours.

The anions of imide-containing salts 160 can be a bis(trifluoromethanesulfonyl)imide (TFSI−), a bis(fluorosulfonyl)imide (FSI⁻), and/or a bis(pentafluoroethanesulfonyl)imide (BETI⁻)−. The cations in these imide-containing salts 160 can be one or more of lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺). It should be noted that imide-containing salts 160 can be also in the form of ionic liquids, which is a salt in a liquid state.

For example, imide-containing salts 160 comprises n-propyl-n-methylpyrrolidinium bis(fluorosulfonyl)imide (Pyr13-FSI) and/or n-propyl-n-methylpyrrolidinium bistrifluoromethanesulfonylimide (Pyr13-TFSI). The concentration of Pyr13-FSI in liquid electrolyte 150 can be between 3% by weight and 30% by weight or, more specifically, between 5% by weight and 25% by weight or, even 10% by weight and 20% by weight. The concentration of Pyr13-TFSI in liquid electrolyte 150 can be between 3% by weight and 40% by weight or, more specifically, between 5% by weight and 30% by weight or, even 10% by weight and 20% by weight. In some examples, liquid electrolyte 150 comprises n-propyl-n-methylpyrrolidinium bis(fluorosulfonyl)imide (Pyr13-FSI) but not n-propyl-n-methylpyrrolidinium bistrifluoromethanesulfonylimide (Pyr13-TFSI), e.g., is free from n-propyl-n-methylpyrrolidinium bistrifluoromethanesulfonylimide (Pyr13-TFSI). Alternatively, liquid electrolyte 150 comprises both n-propyl-n-methylpyrrolidinium bis(fluorosulfonyl)imide (Pyr13-FSI) and n-propyl-n-methylpyrrolidinium bistrifluoromethanesulfonylimide (Pyr13-TFSI). In these examples, the concentrations of n-propyl-n-methylpyrrolidinium bis(fluorosulfonyl)imide (Pyr13-FSI) and n-propyl-n-methylpyrrolidinium bistrifluoromethanesulfonylimide (Pyr13-TFSI) can be substantially the same (e.g., within 5% by weight). In some examples, liquid electrolyte 150 comprises both n-propyl-n-methylpyrrolidinium bis(fluorosulfonyl)imide (Pyr13-FSI) and lithium bistrifluoromethanesulfonylimide (LiTFSI), e.g., in addition to lithium bis(fluorosulfonyl)imide (LiFSI). These can be the only three imide salts in liquid electrolyte 150. In other examples, liquid electrolyte 150 comprises both n-propyl-n-methylpyrrolidinium bis(fluorosulfonyl)imide (Pyr13-FSI) and sodium bistrifluoromethanesulfonylimide (NaTFSI), e.g., in addition to lithium bis(fluorosulfonyl)imide (LiFSI). These can be the only three imide salts in liquid electrolyte 150. In further examples, liquid electrolyte 150 comprises both n-propyl-n-methylpyrrolidinium bis(fluorosulfonyl)imide (Pyr13-FSI) and potassium bistrifluoromethanesulfonylimide (KTFSI), e.g., in addition to lithium bis(fluorosulfonyl)imide (LiFSI). These can be the only three imide salts in liquid electrolyte 150. Some examples of various combinations of imide-containing salts 160 are presented in the following table.

| | FSI-based Salts | | TFSI-based Salts | | | |
|---|---|---|---|---|---|---|
| | Pyr13- | | Pyr13- | | | |
| Electrolyte | FSI | LiFSI | TFSI | LiTFSI | NaTFSI | KTFSI |
| Formulation 1 | Yes | Yes | Yes | — | — | — |
| Formulation 2 | Yes | Yes | — | Yes | — | — |
| Formulation 3 | Yes | Yes | — | — | Yes | — |
| Formulation 4 | Yes | Yes | — | — | — | Yes |
| Formulation 5 | Yes | Yes | — | — | — | — |

In the above examples, n-propyl-n-methylpyrrolidinium (Pyr13⁺) can be substituted with n-octyl-n-methylpyrrolidinium (Pyr18⁺) and/or 1-methyl-1-pentylpyrrolidinium (Pyr15⁺). For example, using Pyr18-cations significantly increases the viscosity of the salt and the resulting electrolyte. In some examples, imide-containing salts 160 comprises potassium bistrifluoromethanesulfonylimide (KTFSI). The concentration of KTFSI in liquid electrolyte 150 can be at least 1% by weight, at least 2% by weight, or even at least 4% by weight. For example, the concentration of KTFSI can be between 0.5% by weight and 10% by weight or, more specifically, between 1% by weight and 5% by weight.

In some examples, imide-containing salts 160 comprises sodium bistrifluoromethanesulfonylimide (NaTFSI). The concentration of Na-TFSI in liquid electrolyte 150 can be at least 2% by weight, at least 4% by weight, or even at least 8% by weight. For example, the concentration of NaTFSI can be between 2% by weight and 15% by weight or, more specifically, between 3% by weight and 10% by weight.

Referring to FIG. 1A, in some examples, imide-containing salts 160 can be also lithium-containing salts 164, e.g., when lithium cations are used. In more specific examples, the only lithium-containing salts 164 in liquid electrolyte 150 are imide-containing salts 160. In other words, liquid electrolyte 150 is substantially free from other (non-imide) lithium-containing salts. These other salts have different lithium metal plating capabilities and can negatively impact the oxidative stability of liquid electrolyte 150. In some examples, the overall concentration of one or more lithium-containing salts 164 in liquid electrolyte 150 is between 15% by weight and 60% by weight or, more specifically, between 25% by weight and 50% by weight of even between 35% by weight and 45% by weight. For comparison, conventional electrolytes (e.g., 1M LiPF₆, ethylene carbonate:dimethyl carbonate in 1:1 volume ratio) have a concentration of lithium-containing salts (e.g., LiPF₆) less than 10% by weight.

In some examples, liquid electrolyte 150 has a viscosity of less than 150 cP, less than 100 cP, or even less than 50 cP. Lower viscosities allow for faster mass/ion transport within liquid electrolyte 150 (e.g. through the separator) resulting in faster charging/discharging capabilities. In some examples, liquid electrolyte 150 has an ionic conductivity of less than 10 mS/cm, less than 5 mS/cm, or even less than 3 mS/cm. This ionic conductivity is lower than that in the conventional lithium-ion electrolytes (e.g., 1M LiPF₆, ethylene carbonate:dimethyl carbonate in 1:1 volume ratio) but generally lower than conventionally used for lithium-metal cells. Specifically, these ionic conductivity values are lower due to high concentrations of lithium-containing salts 164.

In some examples, liquid electrolyte 150 has a lithium-ion activity of at least 370 mV, at least 390 mV, or even at least 400 mV. For purposes of this disclosure, the term “lithium-ion activity” (in the context of liquid electrolyte 150) is defined as the tendency for lithium-ion species to remain or leave liquid electrolyte 150. Specifically, the activity is measured as a potential difference between a reference electrolyte of the known composition and an electrolyte of interest when in contact with a lithium-metal electrode. For example, a reference electrolyte is 1M LiFSI in DME at 25° C. Higher lithium-ion activity values are beneficial because these values imply that the lithium ions have a higher tendency to leave the solution during the plating process, which results in a more even distribution of Li metal at the negative electrode surface and a lower likelihood of dendrite formation.

In some examples, liquid electrolyte 150 comprises both LiTFSI and LiFSI, operable as a lithium-containing salt 162. When both LiTFSI and LiFSI are present, LiTFSI may have a lower concentration than LiFSI in liquid electrolyte 150, e.g., two times lower, three times lower, or even four times lower. For example, too much LiTFSI can cause poor rate capabilities due to the increased viscosity of LiTFSI-containing electrolytes. LiTFSI also showed to have poorer SEI properties in comparison to LiFSI. For example, LiTFSI may have a concentration of at least 3% by weight in liquid electrolyte 150 or, more specifically, at least about 6% by weight, or even at least about 10% by weight. In some examples, the concentration of LiTFSI is between 3% by weight and 25% by weight or, more specifically, between 5% by weight and 15% by weight. In the same or other examples, LiFSI has a concentration of at least 15% by weight in liquid electrolyte 150 or, more specifically, at least about 20% by weight, or even at least about 30% by weight. In some examples, the concentration of LiFSI is between 15% by weight and 45% by weight or, more specifically, between 20% by weight and 35% by weight.

Referring to FIG. 1A, in some examples, liquid electrolyte 150 further comprises one or more solvents 152. Some examples of these solvents include, but are not limited to, 1,2-dimethoxyethane (DME), 2,2,2-trifluoroethyl Ether (TFEE), 1,1,2,2-tetrafluoroethyl 2,2,3,3-tetrafluoropropyl ether (TFPE), tri-ethyl phosphate (TEP), and tri-sodium phosphate (TSP). These solvents may be used to control (e.g., reduce) the viscosity of liquid electrolyte 150 without interfering with other preferable electrolyte properties (such as forming CEI and/or SEI layers using fluorine-containing compounds). In some examples, the concentration of 1,2-dimethoxyethane (DME) in liquid electrolyte 150 is between 5% by weight and 30% by weight or, more specifically, between 10% by weight and 20% by weight. In some examples, the concentration of 2,2,2-trifluoroethyl Ether (TFEE) in liquid electrolyte 150 is between 5% by weight and 20% by weight or, more specifically, between 10% by weight and 15% by weight. For example, 2,2,2-trifluoroethyl Ether (TFEE) can be used in combination with 1,2-dimethoxyethane (DME). In some examples, the concentration of 1,1,2,2-tetrafluoroethyl 2,2,3,3-tetrafluoropropyl ether (TFPE) in liquid electrolyte 150 is between 5% by weight and 40% by weight or, more specifically, between 10% by weight and 30% by weight. For example, 1,1,2,2-tetrafluoroethyl 2,2,3,3-tetrafluoropropyl ether (TFPE) can be used in combination with 1,2-dimethoxyethane (DME) and 2,2,2-trifluoroethyl Ether (TFEE). In some examples, the concentration of tri-ethyl phosphate (TEP) in liquid electrolyte 150 is between 2% by weight and 20% by weight or, more specifically, between 5% by weight and 10% by weight. For example, tri-ethyl phosphate (TEP) can be used in combination with 1,2-dimethoxyethane (DME), 1,1,2,2-tetrafluoroethyl 2,2,3,3-tetrafluoropropyl ether (TFPE), and 2,2,2-trifluoroethyl Ether (TFEE). In some examples, the concentration of tri-sodium phosphate (TSP) in liquid electrolyte 150 is between 0.1% by weight and 5% by weight or, more specifically, between 0.5% by weight and 2% by weight. For example, tri-sodium phosphate (TSP) can be used in combination with tri-ethyl phosphate (TEP), 1,2-dimethoxyethane (DME), 1,1,2,2-tetrafluoroethyl 2,2,3,3-tetrafluoropropyl ether (TFPE), and 2,2,2-trifluoroethyl Ether (TFEE). Overall, liquid electrolyte 150 can comprise one, two, three, four, or five of 1,2-dimethoxyethane (DME), 2,2,2-trifluoroethyl Ether (TFEE), 1,1,2,2-tetrafluoroethyl 2,2,3,3-tetrafluoropropyl ether (TFPE), tri-ethyl phosphate (TEP), and tri-sodium phosphate (TSP).

In some examples, liquid electrolyte 150 is substantially free (less than 1% by weight) from tris(trimethlysilyl) phosphite (TTSPi) and tris(2,2,2-trifluoroethyl) phosphite (TFPi) due to poor performance because of their reductive instability.

In some examples, liquid electrolyte 150 comprises one or more nitrate (NO₃⁻)-based salts, difluoro(oxalato)borate (DFOB⁻)-based salts, and/or difluorophosphate (PO₂F₂⁻)-based salts. These salts can be used in addition or instead of imide-containing salts.

The composition of liquid electrolyte 150 can be also characterized using different designations shown in FIG. 1B. Specifically, the liquid electrolyte 150 may include a diluent 170 and a core mixture 172 comprising a set of salts 180 and a set of solvents 190. The imide-containing salts 160 described above can be a part of the set of salts 180 (e.g., when the imide-containing salt 160 comprises lithium cations as in lithium bis(trifluoromethanesulfonyl)imide (LiTFSI) and/or lithium bis(fluorosulfonyl)imide (LiFSI)) and/or a part of the set of solvents 190 (e.g., when the imide-containing salt 160 comprises n-propyl-n-methylpyrrolidinium (Pyr13) cations). As such, the lithium-containing salts 164, described above, are examples of the set of salts 180. The set of solvents 190 can further comprise an ionic liquid 191 and a molecular solvent 192.

The mole fractions of different components are identified in FIG. 1B with X1, X2, X3, and X4. For example, the mole fraction ratio of the core mixture 172 in the liquid electrolyte 150 (X1) can be between 0.4-0.99 or, more specifically, between 0.7-0.9 or even between 0.75-0.85. In further examples, this molar fraction can be 0.45-0.65 or even between 0.5-0.6. The diluent 170 may include various examples of solvents 152 described above, such as 1, 1,2,2-Tetrafluoroethyl 2,2,3,3-tetrafluoropropyl ether (TFPE). It should be noted that the set of solvents 190, which comprises an ionic liquid 191 and, optionally, a molecular solvent 192 are excluded from the category of diluents 170.

The mole fraction ratio of the set of salts 180 in the core mixture 172 (X2) can be between 0.25-0.55 or, more specifically, between 0.35-0.5, or even 0.43-0.5. It should be noted that the base of this ratio is the core mixture 172 (which excludes the diluent 170). In some examples, the set of salts 180 comprises a salt 181 (e.g., lithium bis(fluorosulfonyl) imide (LiFSI)) and an additional salt 182 (e.g., lithium bis(trifluoromethanesulfonyl)imide (LiTFSI)). In these examples, the mole fraction ratio of the salt 181 in the set of salts 180 can be (X3) is at least 0.5 or, more specifically, at least 0.7, or even at least 0.9. In some examples, the liquid electrolyte 150 comprises only one salt or, more specifically, only one lithium-containing salt (e.g., only lithium bis(fluorosulfonyl) imide (LiFSI)).

As noted above, the set of solvents 190 may comprise an ionic liquid 191 and optionally, a molecular solvent 192. Some examples of ionic liquid 191 include n-propyl-n-methylpyrrolidinium bis(fluorosulfonyl)imide (Pyr13-FSI) and n-propyl-n-methylpyrrolidinium bistrifluoromethanesulfonylimide (Pyr13-TFSI). Other examples of cations (e.g., n-octyl-n-methylpyrrolidinium (Pyr18⁺) and/or 1-methyl-1-pentylpyrrolidinium (Pyr15⁺)) are also within the scope. Some examples of molecular solvent 192 are 1,2-dimethoxyethane (DME). For purposes of this disclosure, the term “molecular solvent” is defined as any solvent that is not an ionic liquid. As such, a molecular solvent can be also referred to as a non-ionic-liquid solvent. Molecular solvents consist of individual molecules (e.g., with covalent bonds), while ionic liquids are composed of ions. In molecular solvents, there are no charged ions present in the solvent molecules themselves. The ionic liquids' ions have an inherent charge and are often chosen to be bulky and asymmetric, which contributes to the unique properties of ionic liquids. The primary distinction between a molecular solvent 192 and a diluent 170 is that the diluent 170 cannot dissolve any salts in the set of salts 180 to any appreciable degree (e.g., above 10's of mM), while a molecular solvent 192 (and an ionic liquid 191) can dissolve any salts in the set of salts 180 to practical levels suitable for battery applications. The mole fraction ratio of the ionic liquid 191 in the set of solvents 190 (X4) can be between 0.01-0.65 or, more specifically, between 0.2-0.5, or even 0.3-0.45. In other examples, the mole fraction ratio of the ionic liquid 191 in the set of solvents 190 (X4) can be between 0.01-0.3 or, more specifically, between 0.05-0.15, or even 0.08-0.13.

### Experimental Examples

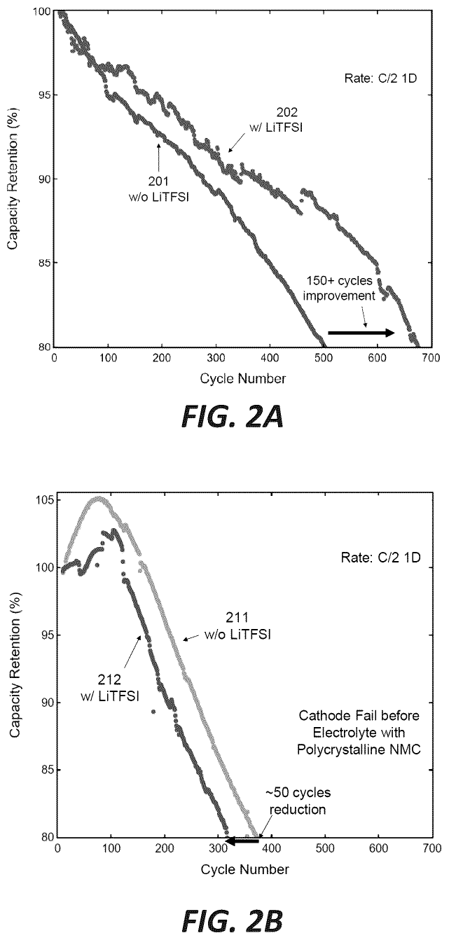

FIG. 2A are capacity retention plots corresponding to two lithium-metal rechargeable electrochemical cells, both fabricated with single-crystal NMC-containing structures. Line 201 corresponds to a cell that was filled with a reference electrolyte, without any TFSI-containing salts. Line 202 corresponds to a cell that was filled with a test electrolyte comprising LiTFSi (i.e., 3% by weight of LiTFSi). The cycling was conducted at a C/2 charge rate and a 1C discharge rate. Besides the addition of LiTFSi, all other electrolyte components were the same. These capacity retention plots illustrate that this addition of LiTFSi helped to improve capacity retention (at the 80% level) by about 150 cycles (from about 500 cycles to over 650 cycles).

FIG. 2B are capacity retention plots corresponding to two lithium-metal rechargeable electrochemical cells, both fabricated with polycrystalline NMC-containing structures. As noted above, polycrystalline structures are different from single-crystal structures (represented in FIG. 2A). Specifically, polycrystalline structures are secondary structures that are formed by the agglomeration of single-crystal structures. The cycling was conducted at a C/2 charge rate and a 1C discharge rate. In FIG. 2B, line 211 corresponds to a polycrystalline-based cell filled with a reference electrolyte without any TFSI-containing salts. Line 211 corresponds to an analogous polycrystalline-based cell that was filled with a test electrolyte comprising LiTFSi. (i.e., 3% by weight of LiTFSi). Besides the addition of LiTFSi, all other electrolyte components were the same. Unlike the improvement in single-crystal-based cells, the addition of LiTFSi worsens the capacity retention in the polycrystalline-based cells.

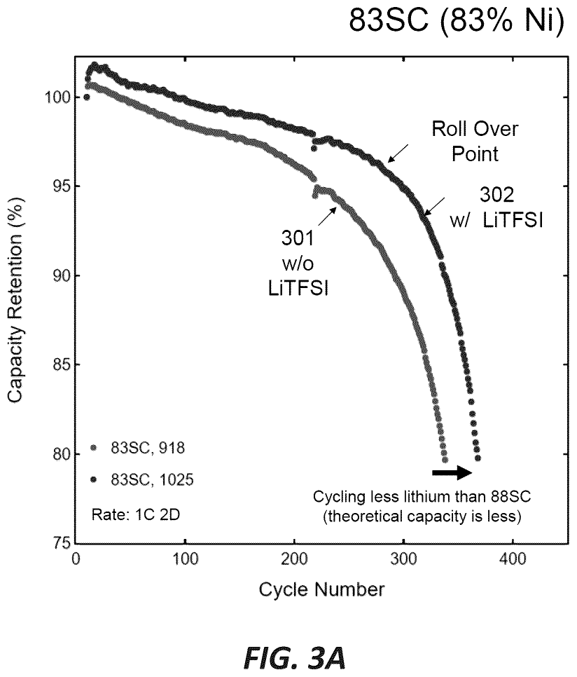

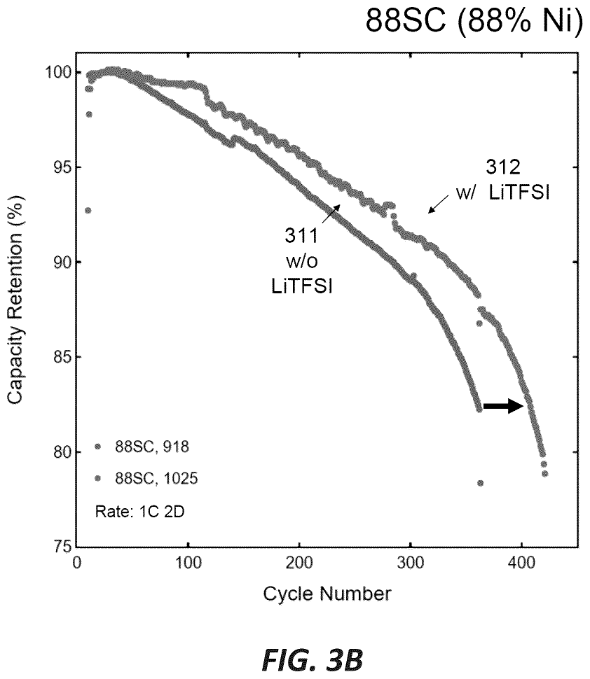

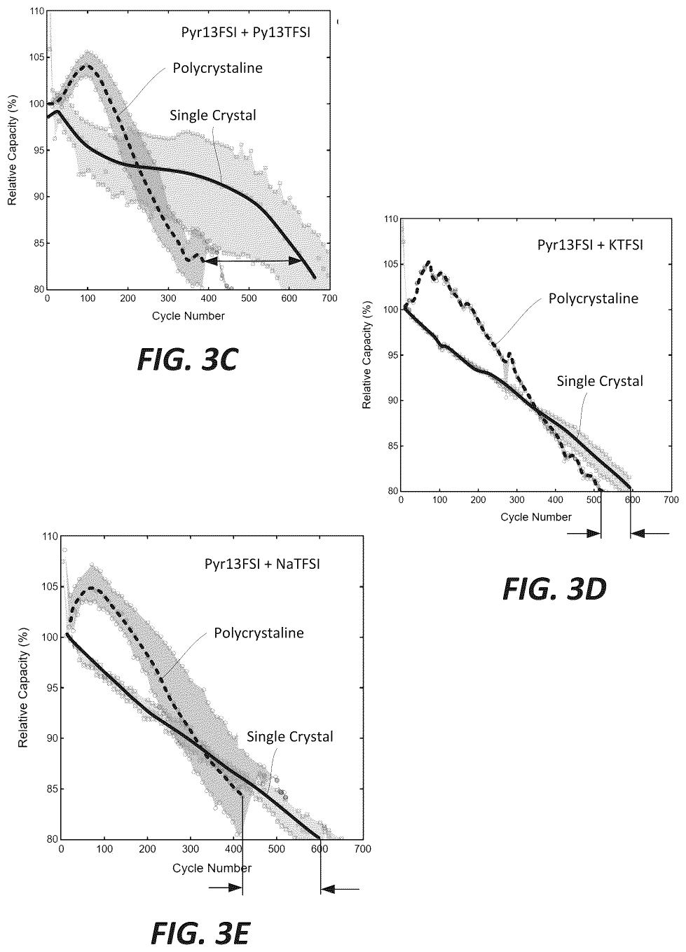

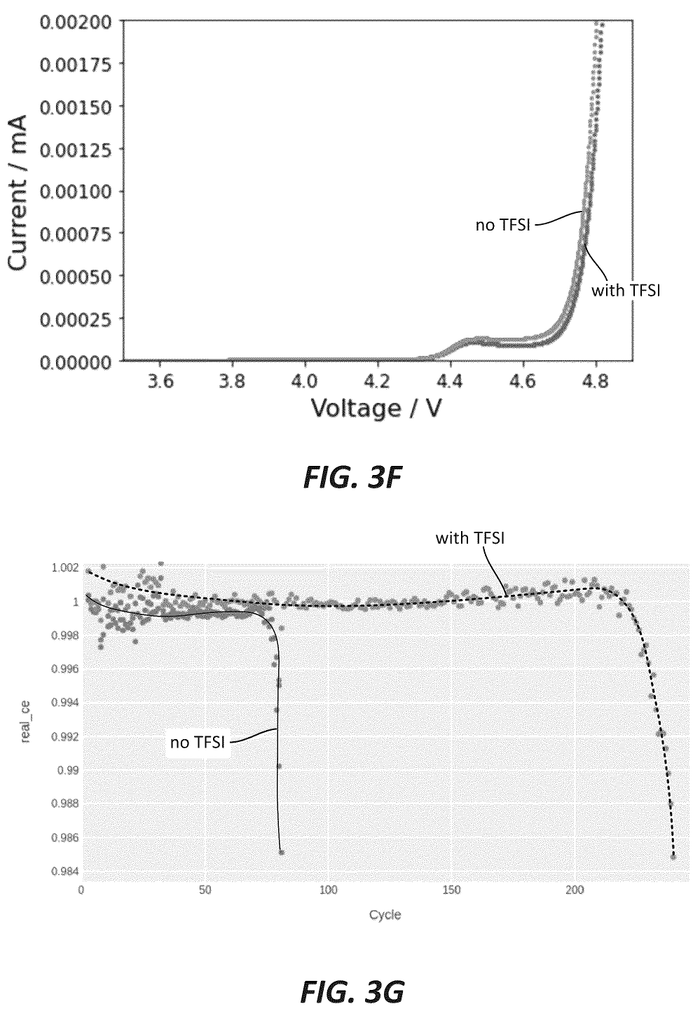

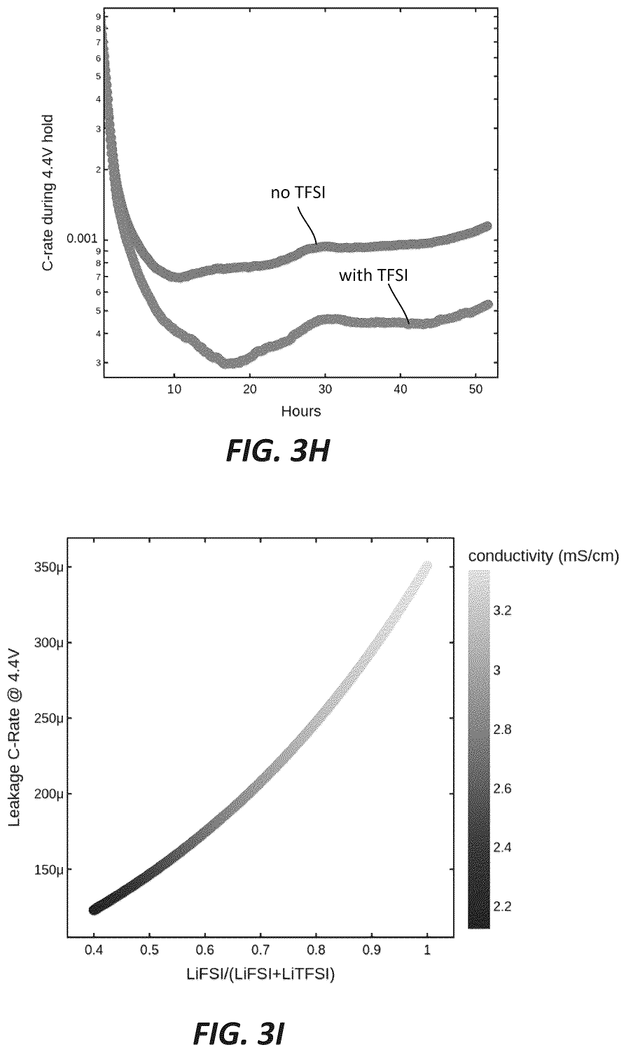

FIG. 3A are capacity retention plots corresponding to two lithium-metal rechargeable electrochemical cells, both fabricated with single-crystal NMC-containing structures (with 83% atomic represented by nickel). Line 301 corresponds to a cell that was filled with a reference electrolyte, without any TFSI-containing salts. Line 302 corresponds to a cell that was filled with a test electrolyte comprising LiTFSi (i.e., 3% by weight of LiTFSi). The cycling was conducted at a 1C charge rate and a 2C discharge rate.

Similarly, FIG. 3B are capacity retention plots corresponding to two lithium-metal rechargeable electrochemical cells, both fabricated with single-crystal NMC-containing structures (with 88% atomic represented by nickel). Line 311 corresponds to a cell that was filled with a reference electrolyte, without any TFSI-containing salts. Line 312 corresponds to a cell that was filled with a test electrolyte comprising LiTFSi (i.e., 3% by weight of LiTFSi). The cycling was conducted at a 1C charge rate and a 2C discharge rate.

Overall, FIGS. 3A and 3B illustrate that the addition of LiTFSi improves the capacity retention for any amount of nickel in single-crystal NMC-containing structures (at least in the 83%-88% range). As noted above, these nickel amounts (Ni-rich NMC materials) are particularly useful from the high-capacity perspective.

FIGS. 3C-3E are capacity retention plots comprising single-crystal NMC-containing structures to polycrystalline NMC-containing structures across different electrolyte formulations. All electrolyte formulations included n-propyl-n-methylpyrrolidinium bis(fluorosulfonyl)imide (Pyr13FSI) as well as ethers and phosphates. Different bis(trifluoromethanesulfonyl)imide (TFSI⁻)-containing salts were tested across these formulations showing a consistent improvement in the capacity retention of the cells fabricated with single-crystal NMC-containing structures (vs. the cells fabricated with polycrystalline NMC-containing structures). FIG. 3F illustrates two oxidative stability curves demonstrating electrolyte oxidative stability with single-crystal NMC-containing structures.

FIG. 3G is a plot of Columbic efficiency over a number of cycles (1C-1D) for two lithium-metal cells, one fabricated with an electrolyte containing DME, LiFSI, and 1,1,2,2-tetrafluoroethyl-2,2,3,3-tetrafluoropropylether (TTE), identified as “no TFSI”, and another one fabricated with a different electrolyte containing DME, LiFSI, LiTFSI, and TTE, identified as “with TFSI”. Both cells contained a single-crystal NMC on the positive electrode. The cell fabrication with the TFSI-containing electrolyte showed a cycle life close to 250 cycles, while the cell fabrication with the no-TFSI electrolyte failed after only 75 cycles.

FIG. 3H are current vs time plots of an electrochemical cell held at 4.4V for 52 hours. The current at the end of this 52-hour hold is referred to as the “oxidative leakage current” and indicates the Faradaic decomposition of the electrolyte against the high voltage, high nickel NMC cathode. The larger in magnitude this current is, the greater the extent of oxidative decomposition the electrolyte is displaying. In this example, the electrolyte containing only LiFSI displays much more oxidative decomposition, than the electrolyte containing both LiFSI and LiTFSI (in which the salt is comprised of 56% LiFSI and 44% LiTFSI). The LiFSI+LiTFSI electrolyte is thus concluded to be much more oxidatively stable than the electrolyte containing only LiFSI with the leakage current measured to be approximately three times less than that of the LiFSI-only electrolyte.

FIG. 3I is a plot showing a model prediction for an electrolyte with X1=0.8, X2=0.45, and X4=0.25 (referring to the ratios defined above) for different values of the X3 ratio (i.e., representing the mole fraction ratio LiFSI to a combination of LiFSI and LiTFSI in the electrolyte system, in which the LiFSI and LiTFSI are the only lithium-containing salts). The leakage current and the electronic conductivity both increase as the amount of LiFSI increases/the amount of LiTFSI decreases. The y-axis values are generated from a data-based model prediction of oxidative leakage current at 4.4V (as modeled from experiments used to generate FIG. 3H) and the color of the trace is colored by model predictions of the ionic conductivity of the electrolyte. As X3 is decreased leakage current is decreased, which indicates a higher degree of oxidative stability. However, the conductivity is also predicted to decrease in conjunction. Thus, it is still necessary for the salt to comprise LiFSI in order to maintain sufficient ion transport.

Additional experiments have been conducted reducing the amount of ionic liquids in electrolyte formulations (e.g., Pyr13FSI) for lithium-metal salts increases the propensity for shorts (leakage current). However, the amount of ionic liquids appears to not impact the cycle life. On the other hand, removing LiTFSI from the electrolyte formulation (also containing LiFSI) negatively impacts the cycle life.

### Method of Fabricating Lithium-Metal Rechargeable Electrochemical Cells

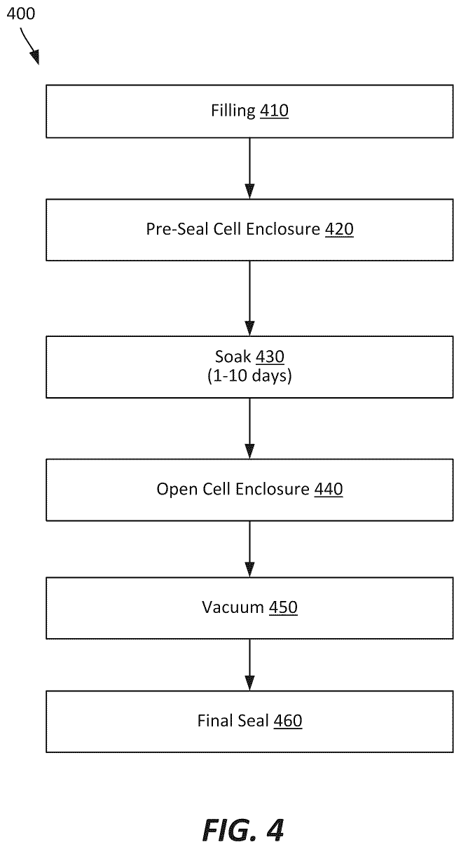

FIG. 4 is a process flowchart corresponding to method 400 of fabricating lithium-metal rechargeable electrochemical cell 100, in accordance with some examples. Method 400 may commence with (block 410) filling cell enclosure 102 (containing lithium-metal negative electrode 110, positive electrode 120, and separator 104) with liquid electrolyte 150. Various examples of liquid electrolyte 150, positive electrode 120, and other cell components are described above with reference to FIG. 1A.

Method 400 may proceed with (block 420) pre-sealing cell enclosure 102 while liquid electrolyte 150 is allowed to soak into separator 104 and to some extent into positive electrode 120. The pre-sealing operation helps to reduce the evaporation of various components of liquid electrolyte 150 and allows for extending the duration of the soaking operation.

Method 400 may proceed with (block 430) soaking lithium-metal rechargeable electrochemical cell 100 for a period (e.g., 1-10 days). This soaking operation ensures that liquid electrolyte 150 soaks into separator 104 and to some extent into positive electrode 120 and provides ionic conductivity within lithium-metal rechargeable electrochemical cell 100 during the cell cycling. [Is there any cycling performed during this cycling operation?]

Method 400 may proceed with (block 440) opening cell enclosure 102 and (block 450) vacuuming the interior of cell enclosure 102 or, more specifically, subjecting the interior of cell enclosure 102 to a reduced pressure to remove any bubbles from liquid electrolyte 150.

Method 400 then proceeds with (block 460) final sealing of cell enclosure 102.

### Application Examples

Lithium-metal rechargeable electrochemical cell 100, described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both applications, as onboard fires while in flight could be mission-critical and cause catastrophic failure of the system. In this scenario, occupants or personnel using the system are not able to simply depart from aircraft and/or spacecraft (e.g., in comparison to ground-based vehicles).

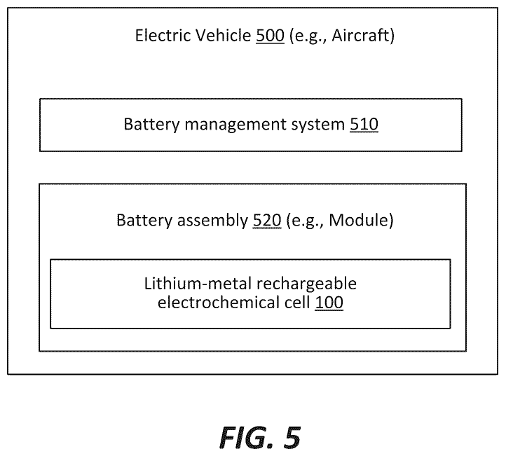

FIG. 5 is a block diagram of aircraft 500 comprising battery assembly 520, which in turn comprises one or more lithium-metal rechargeable electrochemical cells 100. Aircraft 500 also comprises battery management system 510, electrically and communicatively coupled to battery assembly 520. For example, battery management system 510 can receive various operating signals from battery assembly 520, such as state of charge, temperature, voltage, current, and the like.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A lithium-metal rechargeable electrochemical cell comprising:
a lithium-metal negative electrode;
a positive electrode comprising a single-crystal nickel-manganese-cobalt-containing structures; and
a liquid electrolyte providing an ionic conductivity between the lithium-metal negative electrode and the positive electrode and comprising one or more imide-containing salt selected from the group consisting of a bis(trifluoromethanesulfonyl)imide (TFSI⁻)-containing salt, a bis(fluorosulfonyl)imide (FSI⁻)-containing salt, and a bis(pentafluoroethanesulfonyl)imide (BETI⁻)-containing salt.

2. The lithium-metal rechargeable electrochemical cell of claim 1, wherein the one or more imide-containing salts comprise cations selected from the group consisting of lithium (Li⁺), potassium (K⁺), sodium (Na⁺), cesium (Cs⁺), n-propyl-n-methylpyrrolidinium (Pyr13⁺), n-octyl-n-methylpyrrolidinium (Pyr18⁺), and 1-methyl-1-pentylpyrrolidinium (Pyr15⁺).

3. The lithium-metal rechargeable electrochemical cell of claim 1, wherein the one or more imide-containing salts comprise n-propyl-n-methylpyrrolidinium (Pyr13).

4. The lithium-metal rechargeable electrochemical cell of claim 1, wherein the one or more imide-containing salts comprises n-propyl-n-methylpyrrolidinium bis(fluorosulfonyl)imide (Pyr13-FSI).

5. The lithium-metal rechargeable electrochemical cell of claim 4, wherein the n-propyl-n-methylpyrrolidinium bis(fluorosulfonyl)imide (Pyr13-FSI) has a concentration of at least 10% by weight in the liquid electrolyte.

6. The lithium-metal rechargeable electrochemical cell of claim 5, wherein the imide-containing salt further comprises n-propyl-n-methylpyrrolidinium bis(trifluoromethanesulfonyl)imide (Pyr13-TFSI).

7. The lithium-metal rechargeable electrochemical cell of claim 6, wherein the n-propyl-n-methylpyrrolidinium bis(fluorosulfonyl)imide (Pyr13-FSI) has a higher concentration than the n-propyl-n-methylpyrrolidinium bis(trifluoromethanesulfonyl)imide (Pyr13-TFSI).

8. The lithium-metal rechargeable electrochemical cell of claim 6, wherein the propyl-n-methylpyrrolidinium bis(trifluoromethanesulfonyl)imide (Pyr13-TFSI) has a concentration of at least 5% by weight in the liquid electrolyte.

9. The lithium-metal rechargeable electrochemical cell of claim 1, wherein the one or more imide-containing salts have a total concentration of between 10% by weight and 60% by weight.

10. The lithium-metal rechargeable electrochemical cell of claim 1, wherein the one or more imide-containing salts consist of a single imide-containing salt having a concentration of less than 20% by weight.

11. The lithium-metal rechargeable electrochemical cell of claim 1, wherein the one or more imide-containing salts are oxidatively stable at voltages of at least about 4.2V.

12. The lithium-metal rechargeable electrochemical cell of claim 1, wherein the one or more imide-containing salts comprise lithium cations.

13. The lithium-metal rechargeable electrochemical cell of claim 1, wherein the one or more imide-containing salts comprise lithium bis(fluorosulfonyl)imide (LiFSI).

14. The lithium-metal rechargeable electrochemical cell of claim 13, wherein:
the one or more imide-containing salts further lithium bis(trifluoromethanesulfonyl)imide (LiTFSI), and
the lithium bis(trifluoromethanesulfonyl)imide (LiTFSI) has a lower concentration than lithium bis(fluorosulfonyl)imide (LiFSI) in the liquid electrolyte.

15. The lithium-metal rechargeable electrochemical cell of claim 13, wherein lithium bis(trifluoromethanesulfonyl)imide (LiTFSI) has a concentration of less than 5% by weight in the liquid electrolyte.

16. The lithium-metal rechargeable electrochemical cell of claim 1, wherein the liquid electrolyte has a lithium-ion activity of at least 370 mV vs. 1M LiFSI in DME at 25° C.

17. The lithium-metal rechargeable electrochemical cell of claim 1, wherein nickel has a concentration of at least 70% atomic in the single-crystal nickel-manganese-cobalt-containing structures.

18. The lithium-metal rechargeable electrochemical cell of claim 1, wherein the single-crystal nickel-manganese-cobalt-containing structures have an average particle size of less than 8 micrometers.

19. The lithium-metal rechargeable electrochemical cell of claim 1, wherein the liquid electrolyte further comprises one or more solvents selected from the group consisting of 2,2,2-Trifluoroethyl Ether (TFEE) and 1,1,2,2-Tetrafluoroethyl 2,2,3,3-tetrafluoropropyl ether (TFPE).

20. The lithium-metal rechargeable electrochemical cell of claim 19, wherein the one or more solvents comprise both 2,2,2-Trifluoroethyl Ether (TFEE) and 1,1,2,2-Tetrafluoroethyl 2,2,3,3-tetrafluoropropyl ether (TFPE).
